(19) United States
(12) Patent Application Publication
(10) Pub. No.: US 2002/0172331 A1
(43) Pub. Date: Nov. 21, 2002

(54) Telephone message delivering system and method

(76) Inventor: Wade Jonathan David Barker, London (GB)

Correspondence Address: Paul D. Greeley, Esq., Ohlandt, Greeley, Ruggiero & Perle, L.L.P., One Landmark Square, 10th Floor, Stamford, CT, 06901-2682, US

(21) Appl. No.: 09/861,007

(22) Filed: May 18, 2001

(51) Int. Cl. H04M 1/64

(52) U.S. Cl. 379/67.1

(57) ABSTRACT

The present invention provides a telephone message delivering system comprising a call compilation device 140 which includes a processor 141 which receives telephone message delivery data from a sender 100. The telephone delivery data comprises at least the telephone number to which the message is to be delivered. The processor 141 is further configured to transmit a menu to the sender, the menu comprising a list of proprietary pre-recorded tracks, for example music tracks. The sender selects a desired pre-recorded track from the menu and transmits the menu selection back to the processor 141. The sender is also given the option of entering delivery time data for specifying when the call will be delivered and a personalised greeting. The compiled call is transferred to a play processor 151 where it is stored in a call database 152. At the specified time, the play processor 151 transmits a telephone message comprising the track represented by the menu selection to the telephone number 160 identified by the telephone message delivery data. A record of the track played is noted in the play database 153.

The present invention relates to a telephone message delivering system and method.

It is desirable for a first party to be able to send to the telephone of a second party an audible greeting or message. A telephony based delivery system of messages containing selected greetings is disclosed in U.S. Pat. No. 5,787,151. A method of creating and composing audio text messages is described in U.S. Pat. No. 5,146,487. In each of these of cases, a sender can telephone a dedicated line and compose a message for a recipient by a selecting a certain type of greeting and supplying the telephone number of the recipient and other data, such as the time of delivery. In this way, appropriate messages, for birthdays for example, can be sent at the appropriate time to the intended recipient. In each case, the sender can select a short message appropriate to the type of greeting and add their own personalised message. However, the message is limited to selected greetings and any recorded message supplied by the sender. There is no provision for a more complex or more entertaining message.

WO00/36857 discloses a method for implementing a sound message send/receive service in a telecommunication network. In this case, the sender can select a tune or input a tune of heir own which is then sent to the memory of the recipient's mobile telephone, where the recipient can listen to it and if desired use it as the ringing tone for their mobile telephone.

However, due to the limitations of the memory of a mobile telephone, the type of tune which can be delivered will simply comprise the synthesised notes generated by the keys of a mobile telephone. There is no capacity to transmit a more complicated sound.

The present inventors have realised that it is desirable to send a much more appealing message containing for example a track of recorded music. In this way, a message can be sent to recipient which includes their favourite piece of music from the charts or a piece of music specially selected to underline the sender's message.

However, the inventors have realised that the memory of a mobile telephone cannot contain the data necessary to play pre-recorded music and a mobile telephone itself cannot reproduce the recorded music.

Further, intellectual property rights reside in proprietary recorded material such as music, for example performer's rights and copyright in the recording. This kind of recording cannot be distributed at will without the risk of infringing the owners' rights. In particular, the owners of the rights typically are unwilling to grant permission for new recordings to be made.

The present inventors have realised that a telephone message delivering system can be provided which allows a sender to select a pre-recorded track from a menu, to be replayed to the recipient over the telephone lines. In this way, no new recording need be made. It is not dependent upon the memory capacity and reproduction capacity of a mobile telephone. A message can be sent to an ordinary fixed telephone. Copyright problems due to the creation of new recordings are avoided. Further, the inventors have realised that provision should be made to make an entry in a list to provide a record of the number of times a given track has been played so at any necessary royalty payments can be made to the owners of intellectual property rights.

Accordingly, the present invention provides a telephone message delivering system, comprising means for receiving telephone message delivery data from a sender, the telephone delivery data comprising at least a telephone number to which the message is to be delivered,

means for transmitting a menu to the sender, the menu comprising a list of proprietary pre-recorded tracks,

means for receiving from the sender a selection from the menu,

means for transmitting a telephone message comprising at least the track represented by the menu selection to the telephone number identified by the telephone message delivery data, and

means for inputting to storage means a record of the track played.

The present invention further provides a telephone message delivering method, comprising:

receiving telephone message delivery data from a sender, the telephone message delivery data comprising at least a telephone number to which the message is to be delivered,

transmitting to the sender a menu, the menu comprising a list of proprietary pre-recorded tracks

receiving from the sender a selection of at least one track from the menu,

transmitting a telephone message comprising at least the track represented by the menu selection to the telephone identified by the telephone message delivery data and making a record in storage means of the track played.

The person who intends to send the message, hereinafter referred to as the “sender”, will commence the creation of a message by either dialling on their own telephone the telephone number of the system or by using a computer capable of receiving instruction from the telephone message delivering system. For example the sender may employ a computer such as a personal computer to visit the website on which instructions for the use of the telephone message delivering system are presented.

It is essential that the sender should supply the telephone number of the party to whom the message is to be delivered (hereinafter referred to as “the recipient”). This information may be given over the telephone by dictation or by using touch-tone keys of the telephone. Alternatively, if the sender is employing a computer, the telephone number may be typed in.

Preferably, the telephone message delivery data further comprises delivery time data. In this way, the sender will be able to specify a date and optionally a time of day on which the message will be delivered. Again, the delivery time data may be input by dictation, by using touch-tone keys of the telephone or by using a computer to type in characters.

Preferably, a message type menu is transmitted to the sender, the menu comprising a list of message types. The list may include for example birthday greetings, valentines, congratulation messages, Christmas greetings etc. The menu may be in the form of a list presented on a computer terminal, for example a web page of a website or it may be dictated over the telephone to the sender with instructions to select a given message type from the menu by the use of touch-tone keys. The sender may be provided with a preview of the message type selected, for example by being played back to the senders.

In a preferred embodiment, the sender is given an opportunity to provide a greeting to be included in the message to the recipient. Means are preferably provided for receiving a greeting from a sender and for storing the greeting in storage means. The greeting may be dictated by the sender over the telephone or by using a microphone attached to a computer. Alternatively, the greeting may be input manually for example by typing in using a computer or by composing a text message for delivery to a mobile telephone.

The menu comprising a list of proprietary recorded tracks may be provided in any suitable form. For example, it may comprise a list dictated to the sender with instructions to select one of the tracks by the use of touch-tone keys of a telephone. Alternatively, it may be a list provided on the screen of a computer, for example a web page from a website. The sender may select one of the tracks by any suitable means, for example by the use of touch-tone keys, by dictating the name or number of the track required by typing instructions into a computer or by selecting means representing the selection, for example by clicking on an icon. The track may comprise any proprietary recorded audible material, for example music or other recordings, for example recordings of the spoken voice or other recordings in which some intellectual property rights subsist, such as recordings of natural sounds such as animals, birds, rivers etc.

Preferably, a preview of the track selected may be provided. The preview may comprise a short selection from the track requested rather an the whole of the track. Further, the sender may be provided with a preview of the entire composed message. In many cases, owners of intellectual property rights in proprietary recorded material will permit short selections to be played without payment of royalty rights for the purposes of advertising etc. The preview may be of a length less than or equal to the time permitted by the owner of the intellectual property rights for which no royalty is requested.

Suitably, storage means are provided in the form of a call database to which the input telephone message delivery data and menu selection are stored. If present, the message type menu selection and input sender greeting are also stored in the call database.

In this way, a message can be composed and stored ready for delivery to the recipient.

Preferably, the means for transmitting the telephone message to the recipient comprises a dialling means for dialling the number stored in the storage means and message playback means for playing to the telephone dialled a message comprising the track identified by the menu selection. Preferably, the means for transmitting the telephone message includes storage means for storing a plurality of proprietary pre-recorded tracks, means for retrieving from the storage means a track corresponding to the track selection and means for playing the retrieved track. Optionally, if used, a greeting corresponding to the message type menu selection and a sender greeting received from the sender are also played to the recipient. Any suitable dialling means may be used.

It is of course possible that when the dialling means dials the recipient's telephone number, no answer will be obtained. Preferably, the dialling attempt is terminated after a fixed period of time. Preferably, a pre-determined number of attempts to dial the recipient's telephone number are made. For example, five attempts may be made, after which the attempt to contact the number is abandoned. Storage means are suitably provided for recording that the message could not be sent, as me recipient's telephone was not answered.

In many cases, if the recipient is unable to answer their telephone, an answering machine will be triggered to take a message. However, the inventors have realised that it is not acceptable to record the telephone message onto an answering machine, as this would lead to the formation of a recording of the selected track which may infringe intellectual property rights in the recording. Accordingly, means may be provided for receiving a signal from the telephone identified by the telephone message delivery data, the signal receiving means being configured to identify if a telephone answering machine has been obtained and to terminate delivery of the message if a telephone answering machine is identified. For examples he message commencement tone or beep of an answering machine may be identified and trigger the signal receiving means to terminate delivery of the message. Further attempts may be made to contact the number after a telephone answering machine is obtained. Alternatively, a message may be recorded in storage means to indicate that the message could not be delivered properly.

Track menu management means may be provided whereby pre-recorded tracks listed in the menu may be changed. This may be necessary as the music in the charts changes with time.

Suitably, means are provided for receiving payment data from the sender. Payment may be made, in the conventional way, by means of a credit card, debit card or other account. The sender may be required to input the credit card number, debit card number or account number together with any optional payment enabling data such as expiry data of a card, name and address of the account holder, PIN number or any other data necessary to obtain payment. Payment may be made using a dedicated secure payment site, such as a payment server in a manner known in the art.

In an alternative embodiment, pre-payment data may be stored in the telephone message delivering system. This pre-payment data suitably comprises a plurality of pre payment account numbers associated with pre payment account balances. In order to pay for the transmission of a telephone message to the recipient, the sender may transmit a pre payment account number. This will allow the system to confirm in the pre payment data store whether there are sufficient funds in the balance associated with that pre-payment account number to pay for the delivery of the telephone message. If sufficient funds are available, the telephone message can be sent. Preferably, means are provided for confirming to the sender that the message will be sent when it has been confirmed that sufficient funds are available. Suitably, pre payment account management means are provided for applying debits to pre-payment accounts. For example, the accounts may be debited when the sender requires to send a message. Accounts may be credited if the sender supplies payment of finds to a pre-payment account. In one embodiment pre-payment accounts are configured so that they may not receive credits. For example, the pre-payment account may be represented by pre-payment account cards which contain a pre-payment account number. When the cards are sold to prospective senders, they are associated with an opening account balance which is subsequently debited upon use of the pre-payment card by the sender.

In a further embodiment of payment means, the time of the sender's cal may be timed by timing means. Cost computing means may be provided to compute the cost of delivering the telephone message to the recipient and for computing the time that the sender's call must last in order to pay for the cost of delivery. The timing means may be configured to give a signal when the time measured by the timing means is equal to the time computed by the computing means. This will allow a sender to terminate their call knowing sufficient payment has been made. This is particularly useful when using a premium rate line of the type in which the portion of the charge made to the sender for using the premium rate line is remitted to the operator of the telephone message delivering system.

However, this system can also be used if the sender initially contacts the telephone delivering system via a normal or non-premium line. In this embodiment, means may be provided for transmitting dialling instructions to the sender, the dialling instructions comprising instructions to the sender to telephone the telephone message delivering system on a premium rate line, the timing means being configured to measure the time from which the call is received from the sender on the premium rate line.

The present invention further provides a terminal for use by a sender of a telephone message in a telephone message delivering system according to invention. In this embodiment, the terminal will comprise means for transmitting telephone message delivery data to the telephone message delivery system, means for receiving a menu from the message delivering system, the menu comprising a list of pre-recorded tracks, and means for transmitting to the message delivering system a selection of at least one track from the list in the menu.

The telephone message delivery data may include delivery time data. The terminal may be further configured to receive a menu comprising a list of message types and to transmit a selection of at least one message type to the telephone message delivering system.

The terminal may be implemented in a suitable manner, for example by using a touch-tone telephone or a computer such as a personal computer.

The present invention can be implemented by a network of processing apparatuses interconnected by any type of communications network. The network can comprise the internet, an extranet an intranet, a local area network or a wireless network for example. Any suitable communication protocol supported by the communication network can be used.

The processing apparatus can comprise dedicated hardware or programmable hardware or even a combination. The programmable hardware can comprise any suitable programme or device such as general purpose computer. In order to configure the programmable device to operate in accordance with the invention, suitable programme code can be provided to the device using any conventional carry medium, e.g. floppy disk, CD-ROM, tape device or programmable logic device or a transient carrier medium e.g. electrical, optical, microwave or radio frequency signal. An example of the application of a transient signal is the downloading of programme code over the network, e.g. the internet.

In one aspect, the present invention can also be implemented as a business method between the sender, the operator of the telephone message delivering system and the recipient. The use of technical means comprising means for recording when a given music track is played provides the technical benefit of simple and reliable data management, providing a record which can be used both for the purposes of the operator of the telephone message delivery system and to compute royalty payments required to the owner of intellectual property rights in tracks played.

The present invention will be described by way of example only with reference to the accompanying drawing in which:

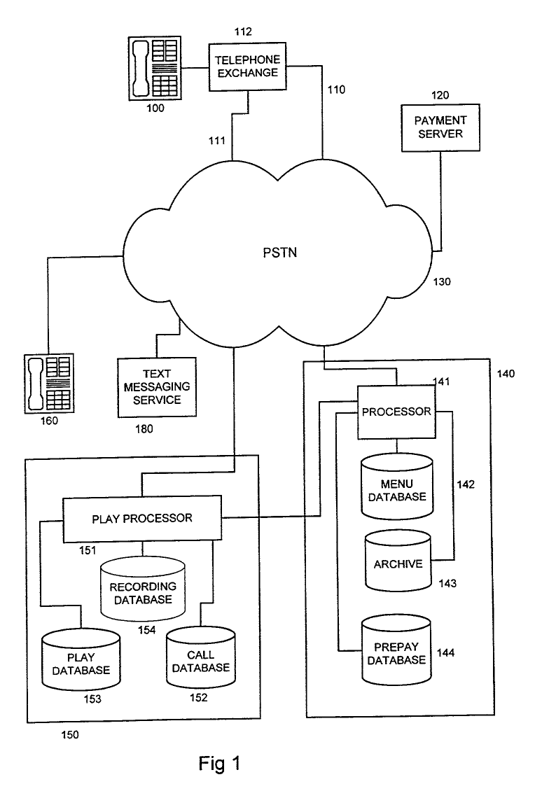

FIG. 1 is a schematic view of an embodiment of a system according to the present invention.

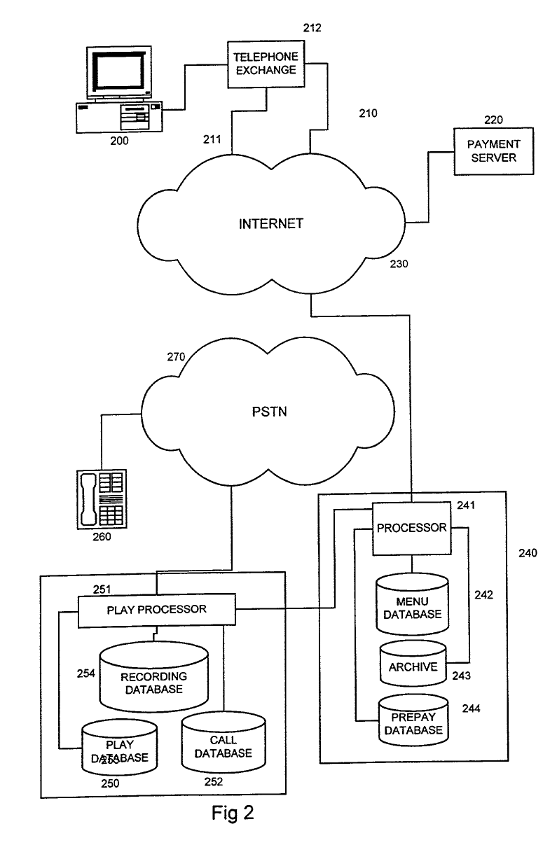

FIG. 2 is a schematic illustration of another embodiment of a system according to the present invention.

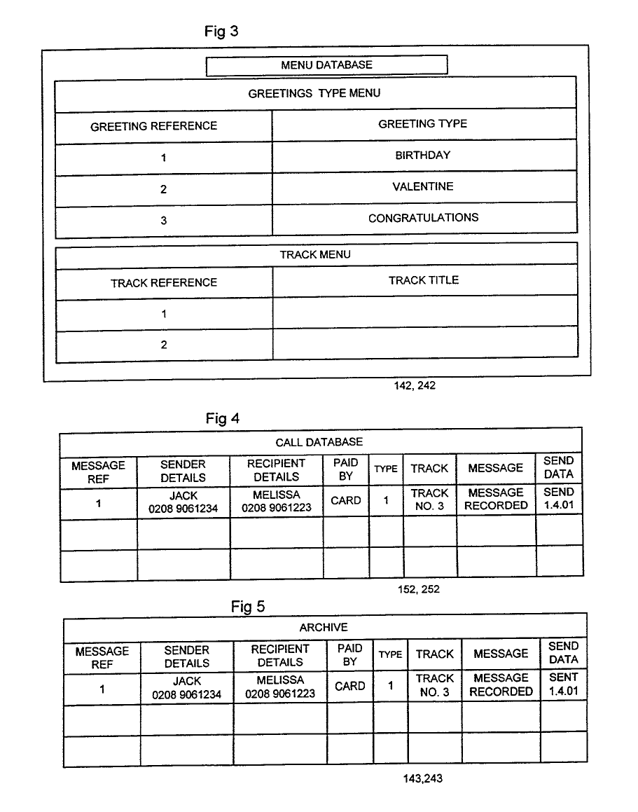

FIG. 3 is a schematic representation of the contents of an embodiment of a track database of FIGS. 1 and 2.

FIG. 4 is a schematic representation of the contents of an embodiment of a call database of FIGS. 1 and 2.

FIG. 5 is a schematic representation of the contents of an embodiment of an archive as used in FIGS. 1 and 2.

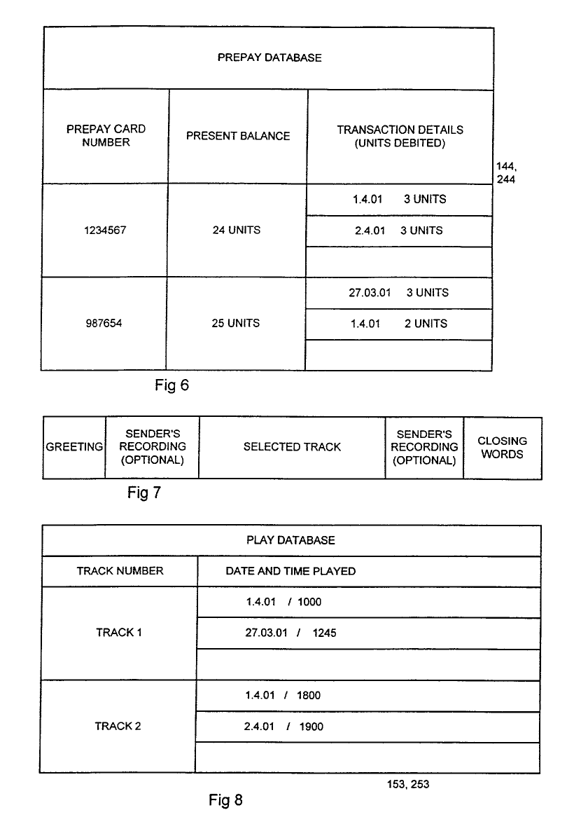

FIG. 6 is a schematic representation of the contents of an embodiment of a pre payment database as used in FIGS. 1 and 2.

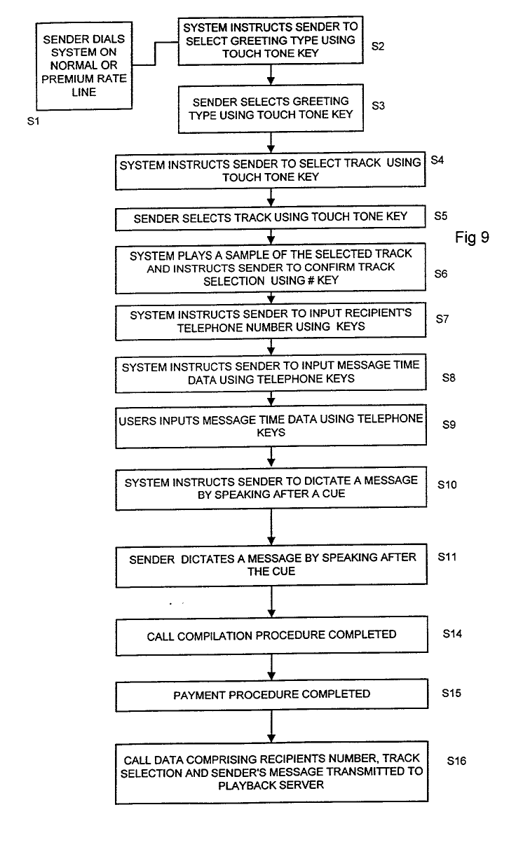

FIG. 7 is a schematic illustration of the structure of an embodiment of a message to be delivered by the system of FIG. 1 or FIG. 2.

FIG. 8 is a schematic representation of the contents of an embodiment of a play database as used in FIG. 1 or FIG. 2.

FIG. 9 shows the steps involved in compiling a message using a telephone.

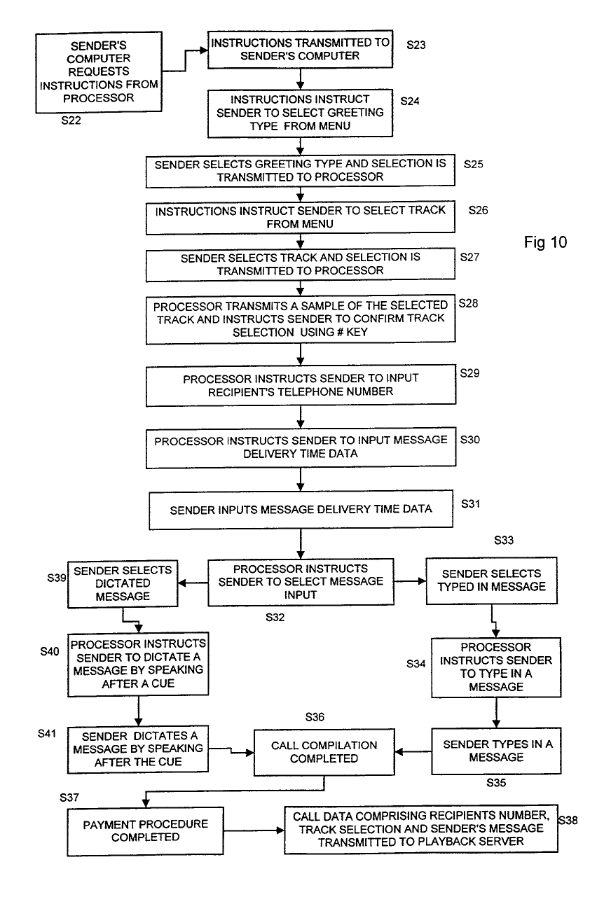

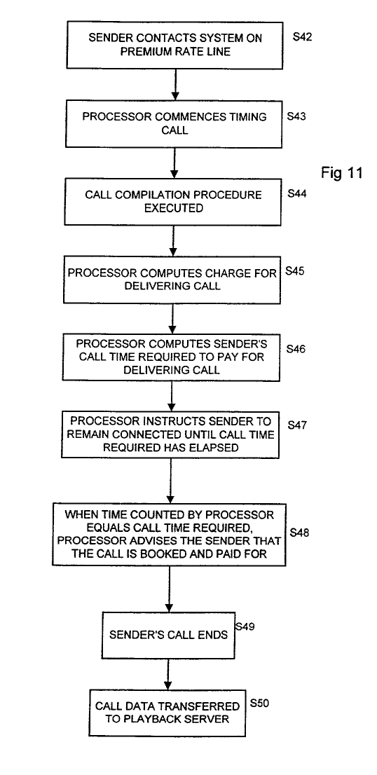

FIG. 10 shows the steps involved in compiling a message using a computer.

FIG. 11 shows the steps involved in one embodiment of a payment procedure.

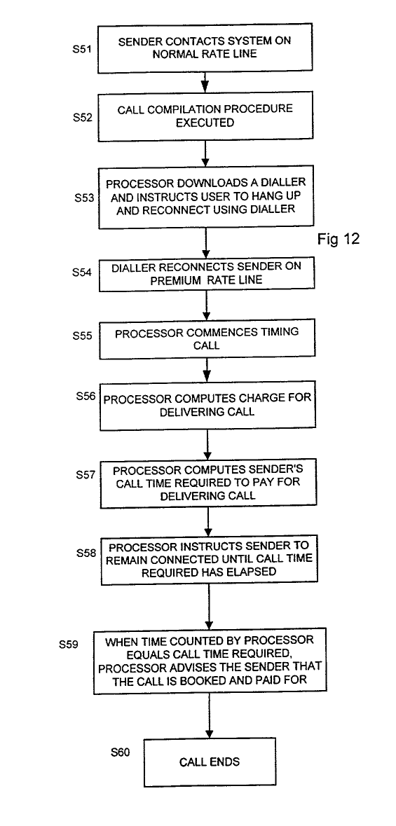

FIG. 12 shows the steps involved in a second embodiment of a payment procedure.

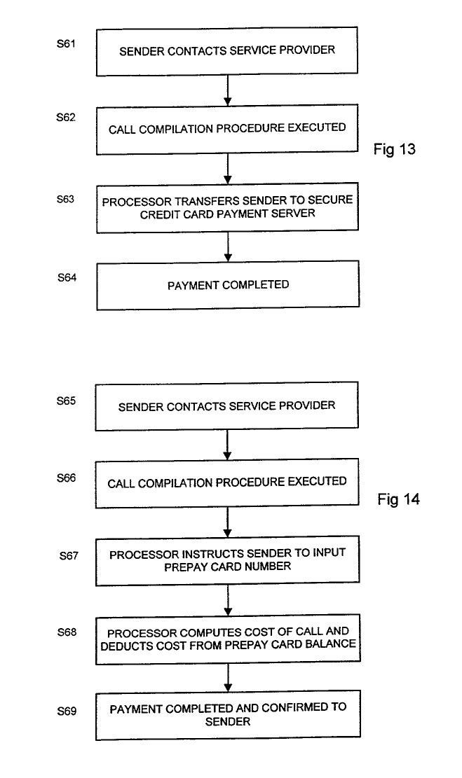

FIG. 13 shows the steps involved in a third payment method.

FIG. 14 shows the steps involved in a fourth payment method.

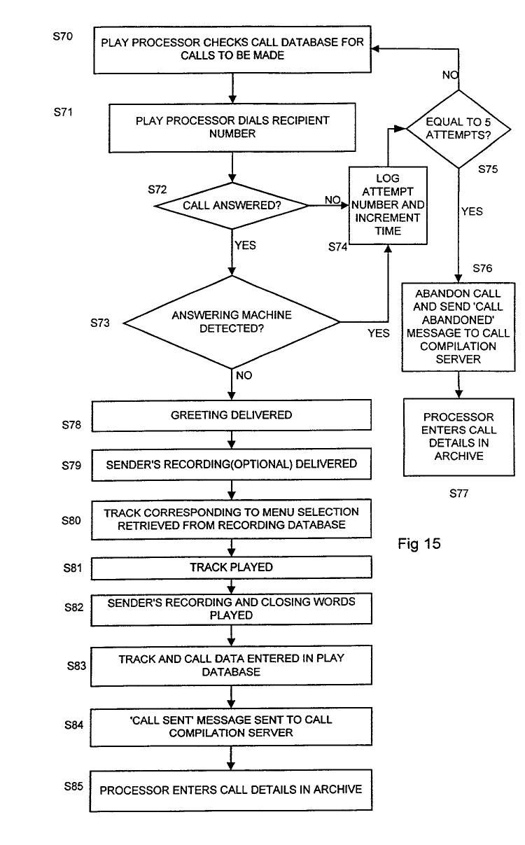

FIG. 15 shows the steps involved in delivering a message to the recipient.

FIG. 1 shows a schematic representation of a network comprising first embodiment of a system according to the present invention. In this embodiment, a sender is able to compile a message by using their own telephone 100. The sender's telephone is connected to the public switch telephone network or PSTN (130).

Also connected to the PSTN is a system according to the present invention comprising a call compilation device 140, a playback device 150 and payment device 120. Also connected to the PSTN is the recipient's telephone 160. A text messaging service 180 is also connected to the PSTN. The sender is able to telephone the call compilation device 140 via the PSTN. The sender may dial a premium rate telephone number which is switched by the telephone exchange 112 through premium rate line 110 or they may dial a normal rate number which is switched by telephone exchange 112 via normal rate line 111. This will be explained further below.

The call compilation device 140 comprises a processor unit 141 which is connected directly to the PSTN 130. The processor is further connected to a track database 142, an archive 143 and a pre-payment database 144 which will be explained further below. The process on 141 is also connected to a play processor 151 of the playback device 150. The playback device 150 further comprises a call database 152 for storing information relating to calls to be made and play database 153 for recording when a given track is played by the play processor 151. Further, there is a recording database 154.

FIG. 2 shows a second embodiment of a network comprising a system according to the present invention. In FIG. 2, the sender is able to employ a computer such as a personal computer 200 to compile messages. Personal computer 200 is connected to the Internet 330 via a premium rate line 210 or a normal rate line 211. In this embodiment of the system of the invention, the system comprises a payment server 220 a call compilation server 240 and a playback server 250. The playback server 250 is connected to the public switch telephone network PSTN 270, to which the recipient's telephone 260 is also connected.

The call compilation server 240 comprises a processor 241 which is connected to a track database 242, an archive 243 and a prepayment database 244. The processor 241 is also connected to the play processor 251 of the playback server 250. The play processor of the playback server is further connected to a call database 252 for storing calls to be made a recording database 254 and a play database 253 for storing a record of when individual tracks are played.

FIG. 3 is schematic representation of the content of the menu database 142 or 242. This comprises a greetings type menu which lists a number of different call types, including a birthday greeting, valentines messages and congratulations messages, each call type being associated with a call reference number. The menu database further comprises at least one track menu comprising a list of a plurality of tracks of recorded music, the track name and a reference number for each track being recorded. There may be single track menu or there may be at least one track menu associated with each greeting type, to allow a sender to select a track which is particularly suitable to the type of greeting selected.

FIG. 4 is schematic representation of the contents of the call database 152 or 252. The call database contains a list of calls ready to be made. Details relating to one call are shown in the figure. A message reference is given to the call to allow it to be referred to later. The call database includes details of the sender, including the sender's telephone number, recipient details, including the recipient's name and telephone number, and details of the payment made for the call by the sender. The call database also includes an identification of the track to be played to the recipient and a message type identification. There is either recording of a message dictated by the sender, a stored written message or text message provided by the sender. Finally, the call database includes send data for indicating when the message is to be sent.

FIG. 5 schematically shows the contents of the archive 143 or 243. In the case shown, the message of FIG. 4 has been sent and the information relating to that message has been recorded in the archive. Exactly the same information is recorded except that the prospective send data has become data setting out when the message was sent.

FIG. 6 schematically shows the content of the pre-pay database. The pre-pay database is used in one embodiment of the method for obtaining payment for the operation of the system of the invention. In the embodiment shown in FIG. 6, a pair of prepay cards have been issued. Each had a balance of 30 units when issued. Each card has been used at various times in the past and the pre-paid database includes a history of the amounts debited and date on which the amounts were debited. In each case, the owner of the respective card can make further requests for messages to be sent to recipients, the cost of delivery of the messages being debited to the pre-pay card account.

FIG. 7 schematically shows the structure of a message which is sent to a recipient by the system of embodiment of the invention. The messages proceeds from left to right, beginning with the selected type of greeting, for example, “Happy Birthday!” The greeting may be optionally followed by sender's recording. In the alternative, the sender's recording may be omitted entirely or may occur later in the message. The recipient will then hear a brief introduction explaining that someone has asked for tune to be played to them to mark the particular event. The introduction may identify the sender if this information has been provided. Then, the selected track is played. The selected track is optionally followed by a recording from the sender. The message is closed by suitable closing words, after which the transmission stops and the recipient hangs up the telephone.

FIG. 8 is a schematic representation of the content of the play database 153 or 253. The play database lists all of the tracks listed in the menu database of FIG. 3. The play database further includes a facility to record, for each track, any date and time on which that track was played. In FIG. 8, dates are shown in numerical format followed by times in 24 hour notation. The operator of the system of the embodiment of the invention is able to calculate royalties due for each respective track on the basis of the number of times the track was played over a given time period.

The recording database 154 or 254 comprises all of the proprietary recorded material listed in the tack menu whereby a track identified by selected track reference can be retrieved from the recording database and played by the play processor 151 or 251.

FIG. 9 shows the steps involved when a sender uses the telephone message delivery system of the embodiment shown in FIG. 1. In this embodiment, the sender will use their telephone 100. The sender will telephone the system 140 using either a premium rate line 110 or a normal rate line 11 as will be explained further below in step 1. In step S2, the processor 141 plays a message to the sender instructing the sender to select a greeting from the greeting type menu using touch-tone keys of the telephone. The processor will then play the greetings type menu from the menu database 142 as follows:

“for birthday greetings, dial 1.

“for valentines greeting, dial 2”

“for congratulations greeting, dial 3.”

In step S3, the sender selects a greeting by dialling the appropriate touch-tone key. Then the processor 141 in step $4 instructs the sender to select a track by pressing the appropriate touch tone key. The processor plays the list in the track menu to the sender by indicating the track title and tack reference to be dialled if that track is required. In step S5, the sender selects a track using the appropriate touch-tone key.

In order to allow the sender to confirm that they have made the correct selection, the processor 141 may play a sample of the selected track in step S6. To do this, the processor 141 will have to access the recording database 154 in the playback server 250. The processor will then instruct the sender to confirm that the selection is correct using a specific key, for example the pound key (#). If the sender uses a different key to indicate that the selection is incorrect, the process returns to step S4. Once the selection has been confirmed the processor 141 will instruct the sender to input the recipient's telephone number using the keys of the sender's telephone in step S7. Once the sender has input the recipient's telephone numbers in step S8, the sender is instructed to input message time data using the telephone keys of the sender's telephone 100, to specify the date and time of delivery of the message or to specify by selecting a specific key, such as the asterisk key that the message should be sent as soon as possible.

In step S10, the processor 141 instructs the sender to dictate a message by speaking after a cue such as a tone. In step S11, the sender dictates their message which is recorded by the processor 141. Call compilation is then complete (step S14) and the processor initiates the payment procedure in step S15. When the payment procedure is completed, the call data comprising the recipient's number, track selection and the sender message is transferred to the playback server 150 where it is stored in the call database 152 (step S16).

The call is then ready for transmission.

FIG. 10 shows the steps involved in compiling a call from a computer such as a personal computer as shown in FIG. 2.

In order to initiate the process the sender will send a request for instructions via their personal computer 200, over a premium rate line 210 or normal rate line 211, via the internet 230 to the server 240. For example, instructions may be requested by downloading the instructions from a website provided by the server 240. In step S23 the instructions are transmitted to the sender's computer 200. In step S24, the instructions instruct the sender to select a greeting type from a menu. For example, the menu could be presented on a web page of the website. The sender selects in step S25 a greeting type, for example by entering the name or number of the greeting type or by selecting means on the screen representing the greeting type. For example the sender may click on an icon representing the greeting type on the screen. In step S26, the instructions instruct the sender to select a track from a menu comprising a list of proprietary recorded tracks. For example, the menu could be presented as a web page on a website. The sender then selects in a step S27 a track. For example, the sender can enter the number of the track selected, the name of the track selected or select means on the screen representing the track. For example the user may click on an icon on the screen of their computer 200. In step S28, the processor transmits a short sample of the selected track to the sender's computer 200 where it can be played if suitable sound reproduction facilities are present in the computer 200. To do this, the processor 251 will have to access the recording database 254 in the playback server 250. This will allow the sender to confirm that the right music track has been selected. The processor can in the sender to confirm that the correct track has been selected by pressing, for example, the pound key (#). If the sender presses another key to indicate that the selection is wrong, the system will return to step S26. When the sender has confirmed that the correct track has been selected, the system will instruct the sender to input the recipient's complete telephone number, including local dialling code, in Step S29. Once this has been done, the processor will instruct the sender to input message delivery time data so hat the message can be delivered at a specific time or on a specific day (step S30). The sender then inputs message delivery time data in Step S31. This can be achieved by typing the desired date and time or by clicking on an icon representing the desired time and day on the screen.

When this is complete, the processor will instruct the sender in step S32 to select a particular type of personal message input. For example, the sender can select a dictated audio message in step S39 or the sender can elect to type in a message using the keyboard of their computer in step S33.

In step S34, if the sender has elected to type in a message, the processor gives them instructions to proceed and in step S35 the sender types in the message. When this is complete, call compilation is completed as noted at step S36.

If the sender selected to dictate a message, in step S39, the processor instructs the sender to dictate their message by speaking into a microphone of the computer 200 (if present) after a cue such as a tone in step S40. The sender will then dictate a suitable message in step S41 and when this is complete, call compilation is ended as noted at step S36. When call compilation is complete the processor 241 will commence the payment procedure. When this is completed at step S37 the call data comprising the recipient's number, the sender's tack selection and the sender s message are transmitted to the playback server 250 where they are recorded in the call database 252 for later playback (step S38). The process is then ended and the sender can log off.

FIG. 11 shows the steps involved in a first embodiment of the payment procedure. In this embodiment, the sender will contact the system by telephoning or logging on to the call compilation server 240 via a premium rate line 110 or 210 as shown in FIG. 1 or 2. As soon as connection is made to the compilation server 140 or 240, a timer in the processor 141 or 241 will commence timing the duration of the call, in step S43. In step S44, the call compilation procedure as described in FIG. 9 or FIG. 10 is executed up to step S14 or S36 respectively. All the time that the call compilation procedure is being executed, the processor will continue to time the sender's call. When the compilation procedure is executed, the processor will compute the charge required to deliver a call to the recipient (step S45). This charge will comprise charges such as telephone company charges which will depend upon time of day and zone to which the call is to be transmitted, royalty fees for playing a selected track and handling fees of the company operating the system of the invention. When his charge has been calculated, the processor will compute the time required for the sender to remain connected via the premium rate line to the compilation server 140 or 240 in order to pay for the call (step S46). This uses the fact that when a premium rate line 110 or 210 is used, a portion of the call charge charged to the sender is remitted to the operator of the compilation server 140 or 240 in a manner well known in the art. The total sum remitted to the operator of the server will depend upon the time for which the sender remains connected and so the processor can calculate the time the sender needs to remain connected. In step S47, the processor displays to the sender the cost of the proposed call to the recipient and will instruct the sender not to disconnect the call until enough time has elapsed to pay for the call to the recipient. In step S48, after the required time has elapsed, the processor gives a signal to the sender that they can now disconnect because the call to the recipient has been paid for and is now booked. The sender will then terminate their call in step S49 and the call data is transferred to the playback server in step S50.

FIG. 12 shows the steps involved in a second embodiment of a payment procedure. In this embodiment, the sender will contact the system either via telephone 100 or computer 200 using a normal rate line 111 or 211. When the call compilation server 140 or 240 is contacted using a normal rate line, no charge accrues to the operator of the call compilation server 140 or 240 as it would if the premium rate line were used. In step S52, the call compilation procedure is completed as shown in FIG. 9 or FIG. 10 upto step S14, or S36 respectively. In step 853, the processor instructs the sender to redial using a premium rate line 110 or 210. In order to achieve this, a packet of information, for example a dialler, may be transmitted to the sender which, when activated by the sender will automatically disconnect the sender from the normal rate line 111 or 211 and reconnect the sender on the premium rate line 110 or 210.

When the sender has redialled using the premium rate line 110 or 210 in step S54 the processor will then go through a series of steps S55, S56, S57, S58, S59 and S60 which are exactly analogous to steps S43, S45, S46, S47, S48 and S49 of FIG. 11 and will not be described further.

FIG. 13 shows the steps involved in a third embodiment of a payment procedure. In this procedure, the sender contacts the service provider by telephone 100 or computer 200 as shown in FIG. 1 or FIG. 2, in step S61 up to step S14 or S36 respectively. In step S62, the call compilation procedure is completed as shown in FIG. 9 or FIG. 10. In step S63, the processor ushers the sender to a secure credit card payment server 120 or 220 as shown in FIG. 1 and FIG. 2 where payment may be completed in a manner known in the art using the sender's credit card details.

FIG. 14 shows the steps involved in a fourth embodiment of a payment procedure according to the present invention. In the procedure of FIG. 14, the sender contacts the service provider in step S65 using the telephone 100 or computer 200 as shown in FIG. 1 or FIG. 2. In step S66, the call compilation procedure is executed as shown in FIG. 9 or FIG. 10 up to step S14 or S36 respectively.

Before contacting the service provider, the sender will have purchased a prepaid card. This prepaid card will have a number to identify it and a certain number of units credited to the card identified by that number. In step S67, the processor instructs the sender to input the number of their prepaid card. In step S68, the processor computes the cost of sending the call to the recipient. The processor 241 or 141 will then inspect the prepay database as shown in FIG. 6. The processor will confirm that the present balance for the specific prepaid card number is sufficient to pay for the call to the recipient. The processor will then deduct the number of units required to pay for the call to the recipient from the balance, record the transaction details and confirm to the sender that the call to the recipient has been booked, in step S69.

FIG. 15 shows the steps involved in an embodiment of the procedure for transmitting the call to the recipient. In step S70, the play processor 151 or 251 checks the respective call database 152 or 252 for calls to be made. In particular, the processor will check the send data and compares the send data of all the entries with a record of time and date in the processor to see if any of the calls have to be made. If the time data of any call equals the time data recorded by the play processor or if the time data simply states that the message is to be sent as soon as possible, the play processor will commence the playback procedure. If a plurality of calls are scheduled for playing as soon as possible or at the same time, they are arranged in a queue in order that they were received by the call database, the earliest to be received being played first. In order to this, in step S71, the play processor dials the recipient's number recorded for a given message. In step S72, the play processor determines if the call is answered within a given time, for example within eight rings. If the call is answered within eight rings, the system proceeds to step S73. If the call is not answered within eight rings, the processor notes the number of the attempt, applies a small increment to the send time in the call database and return the system to step S70 so that the call will be attempted again after the short time interval. In step S74, the number of the attempt is checked to see if it equal to five. If five attempts have been made, the processor will abandon the call and send a “call abandoned” message to the call compilation server 140 or 240. The processor 141 or 241 of the call compilation server 140 or 240 will then transfer the data from the call database to the archive with a note in the send data column that transmission was abandoned.

In step S73, if the call is answered, the processor will monitor the signals received from the recipient's telephone 160 or 260. In particular, the processor is configured to detect the “message-record” tone or beep of an answering machine. If an answering machine is detected, the processor returns the procedure to step S74, making a note of the number of the attempt and applying a small increment to the delivery time data so that another attempt can be made later. If an answering machine is not detected, the system proceeds to step S77 and the message is delivered. The message structure is as shown in FIG. 7. The message may have any suitable time duration, for example in the range half a minute to five minutes, more preferably around one to two minutes. The message is delivered by replaying the greeting and the optional sender's recording which are stored in the call database. The play processor 151 or 251 will then select the track identified by the track selection from the recording database 154 or 254 and play the track to the recipient's telephone. After this, the final, optional sender's recording is played followed by suitable closing words and the call ends.

Once the message has been delivered, in the S83 the processor 151 or 251 makes an entry in the play database 153 or 253 recording the name and number of the track played together with selected call data for example the time and date on which the track was played. This will allow the operator of the system to check the play database at regular intervals to determine what royalty payments have to be made to the owners of intellectual property rights in the tracks played. In step S84, a call sent message is transmitted to the call compilation server 140 or 240. In step S85, the processor of the call compilation server will transfer the call data from the call database 152 or 252 and write it into the archive 143 or 243. At this stage, the send data column will be amended to show when the message was sent.

The present invention has been described above purely by way of example, and modifications can be made within the spirit of the invention, which extends to equivalents of the features described. The invention also consist in any individual features described or implicit herein or shown or implicit in the drawings or any combination of any such features or any generalisation of any such features or combination.

What is claimed is:

1. A telephone message delivering system, comprising:
means for receiving telephone message delivery data from a sender, the telephone delivery data comprising at least a telephone number to which the message is to be delivered,
means for transmitting a menu to the sender, the menu comprising a list of proprietary pre-recorded tracks,
means for receiving from the sender a selection from the menu,
means for transmitting a telephone message comprising at least the track represented by the menu selection to the telephone number identified by the telephone message delivery data, and
means for inputting to storage means a record of the track played.

2. A telephone delivering system according to claim 1, wherein the telephone message delivery data further comprises delivery time data, the transmitting means being configured to transmit the telephone message at the time indicated by the delivery time data.

3. The telephone message delivering system according to claim 1, further comprising means for transmitting a message type menu to the sender, the menu comprising a list of message types, and means for receiving from the sender a selection from the message type menu, the telephone message transmitted corresponding to the message type selection.

4. A telephone message delivering system according to claim 1, further comprising means for receiving a sender greeting from a sender and means for storing the sender greeting in storage means, the means for transmitting the telephone message being configured to transmit the sender greeting with the telephone message.

5. A telephone message delivering system according to claim 1, further comprising storage means to which the telephone message delivery data, menu selection and, optionally, message type menu selection and sender greeting are input, and storage means comprising proprietary pre-recorded tracks whereby a track corresponding to the menu selection may be played from the storage means.

6. A telephone message delivering system according to claim 1, wherein the means for receiving telephone message delivery data, the means for receiving the track menu selection and, optionally the message type menu selection and the sender greeting comprise touch-tone recognition means.

7. A telephone message delivering system according to claim 1, wherein the means for receiving telephone message delivery data, the means for receiving the track menu selection, and optionally, the means for receiving the message type menu selection and the sender greeting are configured to receive signals from a remote computer.

8. A telephone message delivering system according to claim 5, wherein the means for transmitting the telephone message comprises a dialling means for dialling the number stored in the storage means and message play back means for playing to the telephone number dialled a message comprising the track identified by the menu selection and, optionally, a message corresponding to the message type menu selection and a sender greeting.

9. A telephone message delivering system according to claim 1, wherein the telephone message transmitting means is configured to make a pre-determined number of attempts to contact the telephone number identified by the telephone message delivery data and, if the delivery is not possible after the pre-determined number of attempts, to abandon the attempts to deliver the message.

10. A telephone message delivering system according to claim 9, wherein the pre-determined number of attempts is five.

11. A telephone message delivering system according to claim 1, wherein the means for transmitting the telephone message comprises signal receiving means for receiving a signal from the telephone identified by the telephone message delivering data, the signal receiving means being configured to identify if a telephone answering machine has been obtained and to terminate delivery of the telephone message if a telephone answering machine is obtained.

12. A telephone message delivering system according to claim 11, wherein the signal receiving means is configured to identify the recording commencement tone of the answering machine.

13. A telephone message delivering system according to claim 1, further comprising track menu management means, whereby the pre-recorded music tracks listed in the menu may be changed.

14. A telephone message delivering system according to claim 1, comprising means for receiving payment data from the sender.

15. A telephone message delivering system according to claim 14, wherein the means
for receiving payment data comprises means for receiving a credit card number, debit card number or account number from the sender, optionally together with payment enabling data.

16. A telephone message delivering system according to any of claim 1, further comprising means for storing pre-payment data, the pre-payment data comprising pre-payment account balances associated with a plurality of pre-payment account numbers, means for receiving a pre-payment account number from a sender, and pre-payment account management means for applying debits to a pre-payment account identified by the pre-payment account number.

17. A telephone message delivering system according to claim 1, further comprising:
call timing means;
cost computing means, configured to compute the cost of delivering the telephone message to the recipient and for computing the time the sender's call must last to pay the cost of delivery, the timing means being configured to give a signal when the time measured by the timing means is equal to the time computed by the computing means.

18. A telephone message delivering system according to claim 17, further comprising means for transmitting dialling instructions to the sender, the dialling instructions comprising instructions to the sender to telephone the telephone message delivering system on a premium rate line, the timing means being configured to measure the time from which a call is received from the sender on the premium rate line.

19. A telephone message delivering method, comprising:
receiving telephone message delivery data from a sender, the telephone message delivery data comprising at least a telephone number to which the message is to be delivered,
transmitting to the sender a menu, the menu comprising a list of proprietary pre-recorded tracks,
receiving from the sender a selection of at least one track from the menu,
transmitting a telephone message comprising at least the track represented by the menu selection to the telephone number identified by the telephone message delivery data, and
making a record in storage means of the track played.

20. A telephone message delivering method according to claim 19, wherein the telephone message delivery data includes delivery time data, the step of transmitting the telephone message occurring at the time indicated by the delivery time data.

21. A telephone message delivering method according to claim 19, further comprising the step of transmitting to the sender a message type menu, the menu comprising a list of message types, and receiving from the sender a selection from the message type menu, wherein the step of transmitting the telephone message further comprises the stop of including a message corresponding to the message type selected.

22. A telephone message delivering method according to claim 19, further comprising the step of receiving from the sender a greeting and storing the greeting in storage means, the step of transmitting the telephone message further including transmitting the sender greeting.

23. A telephone message delivering method according to claim 22, wherein the sender greeting is in the form of a recorded voice greeting.

24. A telephone message delivering method according to claim 22, wherein the sender greeting in the form of a text message.

25. A telephone message delivering method according to claim 19 wherein the step of transmitting the telephone message comprises the steps of dialling the telephone number identified by the telephone message delivery data and playing the track corresponding to track menu selection and, optionally, playing a greeting corresponding to the greeting type selection and a sender greeting, if the telephone identified by the telephone number is answered.

26. A telephone message delivering method according to claim 25, wherein a fixed number of attempts are made to dial the number identified by the telephone message delivery data, after which the call is abandoned.

27. A telephone message delivering method according to claim 26, wherein the call is abandoned after five attempts.

28. A telephone message delivering method according to claim 19, further comprising step of receiving signals from the telephone identified by the telephone number and identifying signals corresponding to an answering machine and terminating the call if the answering machine is identified.

29. A telephone message delivering method according to claim 28, wherein an answering machine is identified by the message commencement tone.

30. A telephone message delivering method according to claim 19, further comprising the step of receiving payment data from the sender.

31. A telephone message delivering method according to claim 30, wherein the payment data comprise a credit card number, debit card number or account number and, optionally, payment enabling data.

32. A telephone message delivering method according to claim 19, further comprising the steps of holding accounts in storage means and adjusting the accounts when a sender uses the system or when a payment is received.

33. A message delivering method according to claim 32, wherein the accounts represent pre-payment accounts.

34. A telephone message delivering method according to claim 19, further comprising the step of measuring the time of a sender's call, calculating the cost of delivering the telephone message to the recipient calculating the time required for the sender's call to pay for the cost of delivering the message to the recipient and giving a signal when the time of the sender's call is equal to the calculated time.

35. A telephone message delivering method according to claim 34, further comprising the step of transmitting instructions to the sender, the instructions instructing the sender to telephone on a premium rate line and receiving the sender's call on the premium rate line, and measuring the time of the senders call on the premium rate line.

36. A terminal for use by a sender of a telephone message in a telephone message delivering system according to claim 1, comprising
means for transmitting telephone message delivery data to the telephone message delivery system;
means for receiving a menu from the message delivering system, the menu comprising a list of pre-recorded music tracks,
means for transmitting to the message delivering system a selection of at least one track from the list in the menu.

37. A terminal according to claim 36 wherein the telephone message delivery data includes delivery time data.

38. A terminal according to claim 36 being further configured to receive a menu comprising a list of message types and to transmit a selection of at least one message type to the telephone message delivering system.

39. A terminal according to claim 36, being a touch tone telephone.

40. A terminal according to claim 36, being a personal computer.

41. Computer programme code for controlling a computer to carry out the method according to claim 19.

42. A carrier medium carrying the computer programme code according to claim 41.

43. A telephone message delivering server for use in a method of delivering telephone messages, the server comprising
a network interface connecting a server to a network to which there are connected at least one sender of a message and at least recipient of a message;
a message storage device storing telephone message delivery data comprising the telephone number of the recipient and a selection from a menu of proprietary pre-recorded tracks;
a play data storage device storing records of tracks played;
instruction memory storing computer implementable instructions; and
a processor operable to read the telephone message delivery data in accordance with the instructions stored in the instruction memory, wherein the instructions stored in the instruction memory comprise instructions for controlling the processor to;
receive from a sender a telephone number to which the message is to be delivered,
transmit to the sender a menu comprising a list of proprietary pre-recorded tracks,
receive from the sender a selection from said menu,
input said telephone number and said menu selection to said storage means,
transmit a telephone message comprising at least a track represented by said menu selection to the telephone number, and
input to the play data storage means a record of the track played.

44. An electronic telephone message delivering method, comprising configuring a data processor to store telephone delivery data comprising at least a telephone number to which a message is to be delivered and a selection from a menu of proprietary pre-recorded tracks,
receiving from a sender a telephone number to which a telephone message is to be delivered,
transmitting a menu to the sender, said menu comprising a list of proprietary pre-recorded tracks,
receiving from the sender a selection from said menu
storing said menu selection and said telephone number as a data record,
transmitting a telephone message comprising at least the track represented by said menu selection to said telephone number identified by said data record and storing in a play data record a record of the track played,
